(19) United States
(12) Patent Application Publication
(10) Pub. No.: US 2006/0097170 A1
(43) Pub. Date: May 11, 2006

(54) Device for corona treatment of electrically insulating materials, especially plastic films

(76) Inventors: Eckhard Prinz, Hamfelde (DE); Frank Forster, Hamburg (DE); Peter Palm, Hamburg (DE)

Correspondence Address: FRIEDRICH KUEFFNER, 317 MADISON AVENUE, SUITE 910, NEW YORK, NY, 10017, US

(21) Appl. No.: 11/251,082

(22) Filed: Oct. 14, 2005

(30) Foreign Application Priority Data
Oct. 15, 2004 (DE) 20 2004 016 083.8

(51) Int. Cl. H01T 19/04

(52) U.S. Cl. 250/324; 250/326

(57) ABSTRACT

A device for corona treatment of electrically insulating plastic films has a counter electrode across which a plastic film to be treated is guided and a high-voltage electrode extending transversely to a travel direction of the plastic film. The high-voltage electrode has several electrode segments extending in the travel direction of the plastic film to be treated. The electrode segments are arranged to be pivotable transversely to the travel direction out of a treatment area. Discharge edges of the electrode segments are divided into individual discharge tongues spaced apart from one another in the travel direction of the plastic film and project in a direction toward the plastic film. The discharge tongues of adjacently positioned electrode segments are staggered relative to one another in the travel direction of the plastic film such that the discharge tongues are positioned tongue on gap.

### BACKGROUND OF THE INVENTION

1. Field of the Invention

The invention relates to a device for corona treatment of electrically insulating materials, especially plastic films. The device comprises a counter electrode across which the plastic film to be treated is guided. The device further comprises a high-voltage electrode that extends transversely to the travel direction of the plastic film and is composed of a plurality of electrode segments. The electrode segments are oriented in the travel direction of the plastic film to be treated and are pivotable transversely to the travel direction out of the treatment area.

2. Description of the Related Art

Such devices are known in various configurations. In the finishing industry or in the manufacture of plastic films, the surface of the plastic films is activated by a plasma treatment, also referred to as corona treatment. This is realized frequently with air as a processing gas but can also be done in a foreign gas atmosphere. The gases that are produced during the discharge processes, in particular, ozone, are removed by suction. The device is comprised of a high-voltage electrode and a counter electrode that is normally embodied as a roller across which the plastic film is guided tightly. The high-voltage electrode is arranged parallel to the roller and is supplied with high-voltage of approximately 10 kV at approximately 20-40 kHz. The roller is connected to ground. In the air gap between the high-voltage electrode and the counter electrode across which the plastic film is guided a corona discharge is created because of the potential difference. The plastic film is activated by the corona discharge, i.e., the surface is oxidized.

By means of the activation the surface tension of the plastic film is increased in order to ensure in this way sufficient adhesion for printing ink and adhesives. When the plastic films are the starting material for bags or sacks and the like, the plastic films should not be treated in the area of the sealing seams by corona treatment because such a treatment would greatly reduce the sealing seam strength. In order to achieve this, the corona discharge must be masked in this area in the travel direction of the plastic film. This is achieved by segmenting the high-voltage electrode and by turning away, pivoting away or moving away individual electrode segments that are arranged closely adjacent to one another without leaving gaps. In the area or areas where the corona discharge is masked, there is no corona discharge because of the distance to the counter electrode. The potential difference is not sufficient. In the areas where corona discharges is not masked, the plastic film is treated because in these areas the plastic film is usually printed on or provided with an adhesive.

In known segment electrodes the surface activation in the travel direction of the plastic film is not uniform, i.e., strips having a reduced surface tension are produced where the adhesion during printing is not ensured. This non-uniform activation is the result of the lateral flanges of the adjacently arranged electrode segments because a stronger discharge takes place transversely to the travel direction at the sharp edges of the abutting parts.

### SUMMARY OF THE INVENTION

It is an object of the present invention to provide a device of the aforementioned kind by which a uniform corona treatment of electrically insulating materials, especially plastic films, is enabled.

In accordance with the present invention, this is achieved in that the discharge edges of the electrode segments are divided into individual discharge tongues that are spaced from one another in the travel direction of the plastic film and project in the direction toward the plastic film and in that the discharge tongues of neighboring electrode segments in the travel direction of the plastic film are staggered or displaced relative to one another such that the discharge tongues of a first electrode segment are aligned with gaps between the discharge tongues of an adjacent second electrode segment (“tongue on gap”).

According to the invention, the discharge edges are divided in the transverse and longitudinal directions into individual projecting discharge tongues and the discharge tongues of neighboring electrode segments are staggered relative to one another tongue on gap. In this way, a much more uniform surface treatment is achieved because the ignition behavior of the corona discharge is improved. Concretely, the electrical energy required for uniform ignition of the corona discharge can be lowered; in spite of this, the discharge remains uniform and strips do not occur. The number of discharge tongues of neighboring electrode segments must not be identical.

Advantageously, the electrode segments are spaced relative to one another transversely to the travel direction of the plastic film and are narrower than in the longitudinal direction. In this way, the treatment gases, whether air or a foreign gas, can be removed by suction uniformly through the high-voltage electrode so that a more effective cooling of the segments is provided.

Finally, it is also possible to crank or offset or bend or displace in other ways the electrode segments out of the plane of the individual electrode segments so that the discharge tongues of the electrode segments are not positioned on a straight line. In the travel direction of the plastic film, the discharge tongues of the electrode segments are staggered or offset so that a correspondingly wider “treatment strip” results which provides for an even more uniform result of the surface treatment.

### BRIEF DESCRIPTION OF THE DRAWING

In the drawing:

FIG. 1 is a schematic cross-section of one embodiment of the device according to the present invention;

FIG. 2 is a view onto the high-voltage electrode of the embodiment according to FIG. 1 from below;

FIG. 3 is a view onto the high-voltage electrode of FIG. 1 from the left; and

FIG. 4 is a view corresponding to FIG. 2 but of a different embodiment with electrode segments that are not cranked (bent).

### DESCRIPTION OF THE PREFERRED EMBODIMENTS

The device illustrated in FIGS. 1 through 3 is comprised of a high-voltage electrode 1 that is arranged in a vacuum housing 3 with suction socket 4. The high-voltage electrode 1 has positioned opposite thereto a counter electrode 2 in the form of a roller electrode. The plastic film to be treated (not illustrated) is guided across this counter electrode 2.

The high-voltage electrode 1 is comprised of several electrode segments 6 having discharge edges extending in the travel direction of the plastic film to be treated, i.e., perpendicularly to the axial direction of the counter electrode 2 in the form of a roller. The individual electrode segments 6 are pivotably or rotatably mounted on a shaft 8 so that they can be swivelled out of the treatment position into a non-treatment position 6a. This is clearly shown in FIG. 1. In the non-treatment position 6a a surface activation is not realized so that a future sealing or the like can be realized without impairment. A stop bar 9 is illustrated against which the individual electrode segments 6 can be pivoted for assuming the treatment position; they are precisely arrested in this position. Each electrode segment 6 has a corresponding nose 10 that contacts the stop bar 9 in the treatment position. A holder 5 for supporting the shaft 8 is a stationary part of the housing.

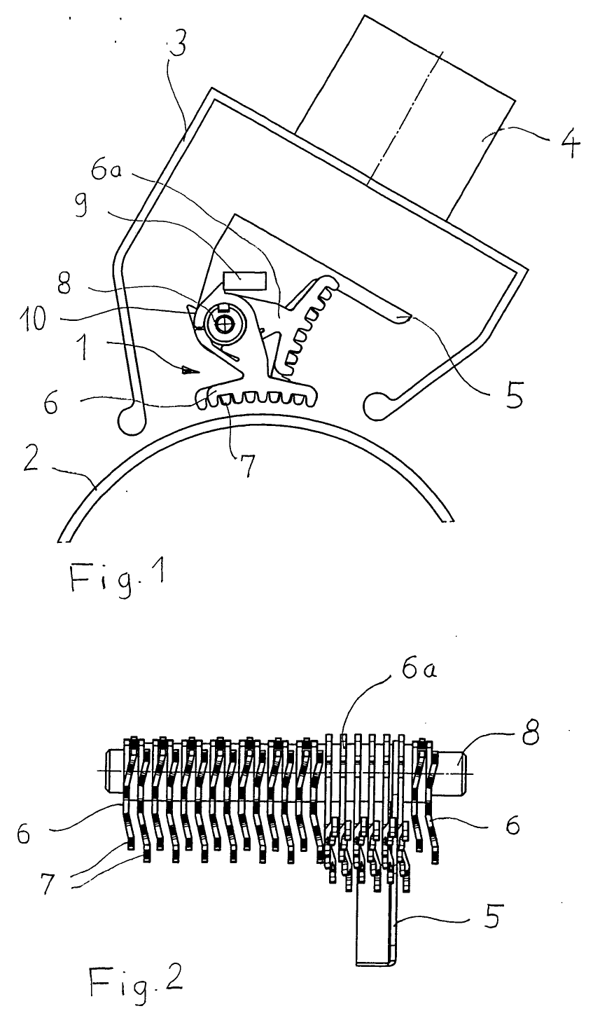

The discharge edges of the electrode segments 6 have discharge tongues 7 that are spaced from one another in the travel direction of the plastic film and project toward the plastic film. The spacing of the tongues 7 relative to one another can be 1 mm to 20 mm, preferably 5 mm to 10 mm. The discharge tongues 7 of two neighboring electrode segments 6 are staggered relative to one another in the travel direction of the plastic film, i.e., they are positioned tongue on gap; this is apparent when looking at FIGS. 1 and 2. In this way, a much more uniform surface treatment is achieved.

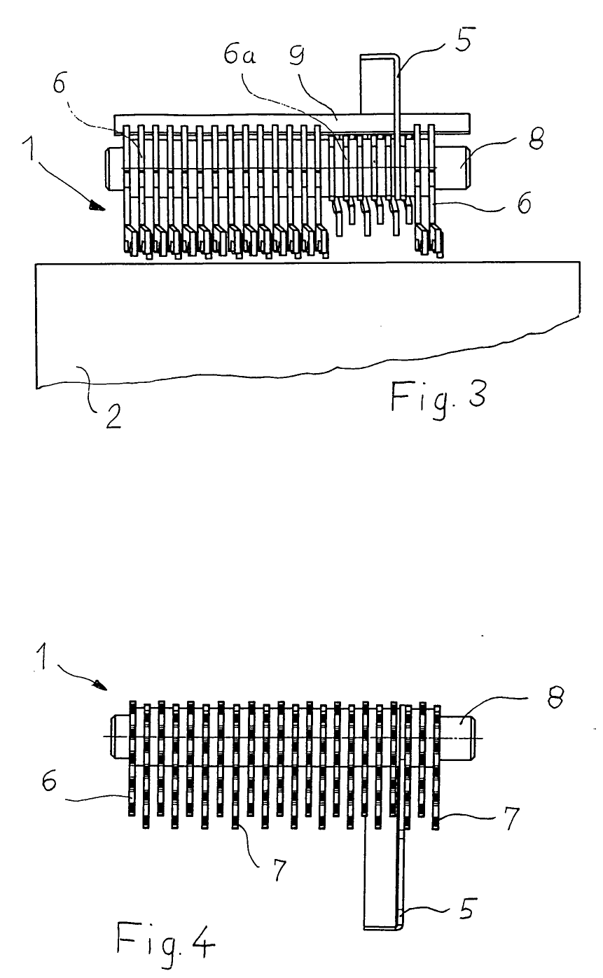

Moreover, in the embodiment according to FIGS. 2 and 3, the discharge edges with their discharge tongues 7 are laterally cranked or offset out of the plane of these discharge edges so that the discharge tongues in the travel direction of the plastic film are not positioned on a single line. In this way, the treatment strip becomes wider and, because of “overlap”, the treatment is made even more uniform.

In the embodiment according to FIG. 4, there is no cranking or bending out of the plane of the discharge edges. This embodiment only shows a staggered arrangement of the discharge tongues 7 relative to one another, i.e., in electrode segments positioned adjacent to one another the position of the discharge tongues is “tongue on gap”, as illustrated in FIG. 1.

Usually, two to 20, preferably five to seven discharge tongues 7 are provided. A distance between the electrode segments is within a range of one to three times a thickness of the electrode segments, respectively. An electrode segment has a thickness of 1 mm to 10 mm, preferably 1.5 to 2.5 mm. The spacing between neighboring electrode segments is 1 to 20 mm, preferably 2.5 to 5 mm. The spacing between the electrode segments and the plastic film on the counter electrode is 0.5 mm to 10 mm, preferably 1.5 mm. The individual electrode segments are made of stainless steel.

Usually, the treatment is carried out at atmospheric pressure. However, it is also possible to employ vacuum in the range of 500 millibar or to work at overpressure.

The electrodes are supplied with a high-voltage of 10 kV to 60 kV wherein a frequency of 5 kHz to 100 kHz is used.

Since the electrode segments are provided with individual discharge tongues that are spaced apart from one another in the travel direction of the plastic film and, in the case of neighboring electrode segments, are staggered relative to one another tongue on gap, a much more uniform surface activation is achieved. The cranking or offsetting of the individual electrode segments ensures “overlap” of the treatment zones and thus ensures a more uniform treatment. The spacing between the individual electrode segments enables an improved and more uniform air flow for cooling and removal by suction.

While specific embodiments of the invention have been shown and described in detail to illustrate the inventive principles, it will be understood that the invention may be embodied otherwise without departing from such principles.

What is claimed is:

1. A device for corona treatment of electrically insulating plastic films, the device comprising:
a counter electrode across which a plastic film to be treated is guided;
a high-voltage electrode extending transversely to a travel direction of the plastic film;
the high-voltage electrode comprising several electrode segments extending in the travel direction of the plastic film to be treated and arranged to be pivotable transversely to the travel direction out of a treatment area;
wherein discharge edges of the electrode segments are divided into individual discharge tongues spaced apart from one another in the travel direction of the plastic film and projecting in a direction toward the plastic film; and
wherein the discharge tongues of adjacently positioned electrode segments are staggered relative to one another in the travel direction of the plastic film such that the discharge tongues are positioned tongue on gap.

2. The device according to claim 1, wherein the adjacently positioned electrode segments are spaced at a distance from one another transversely to the travel direction of the plastic film.

3. The device according to claim 2, wherein the distance between the electrode segments is within a range of one to three times a thickness of the electrode segments, respectively.

4. The device according to claim 1, wherein the electrode segments are cranked or offset transversely to the travel direction of the plastic film.

5. The device according to claim 1, wherein the individual electrode segments are made of stainless steel.
